(19) United States
(12) Patent Application Publication
(10) Pub. No.: US 2015/0138779 A1
(43) Pub. Date: May 21, 2015

(54) LIGHTWEIGHT LOW PROFILE SOLID STATE PANEL LIGHT SOURCE

(71) Applicants: William R. Livesay, San Diego, CA (US); Scott M. Zimmerman, Basking Ridge, NJ (US); Richard L. Ross, Del Mar, CA (US); Eduardo DeAnda, San Diego, CA (US)

(72) Inventors: William R. Livesay, San Diego, CA (US); Scott M. Zimmerman, Basking Ridge, NJ (US); Richard L. Ross, Del Mar, CA (US); Eduardo DeAnda, San Diego, CA (US)

(73) Assignee: Goldeneye, Inc., San Diego, CA (US)

(21) Appl. No.: 14/566,696

(22) Filed: Dec. 10, 2014

Related U.S. Application Data
(63) Continuation-in-part of application No. 14/204,476, filed on Mar. 11, 2014.
Application No. 14/204,476 is a continuation-in-part of application No. 14/042,569, filed on Sep. 30, 2013, now Pat. No. 8,704,262.
Application No. 14/042,569 is a continuation-in-part of application No. 13/572,608, filed on Aug. 10, 2012, now Pat. No. 8,575,641.
Application No. 13/572,608 is a continuation-in-part of application No. 13/986,793, filed on Jun. 5, 2013.
(60) Provisional application No. 61/914,373, filed on Dec. 10, 2013.

(51) Int. Cl. F21S 8/02; F21V 29/507; F21K 99/00

(52) U.S. Cl. CPC F21S 8/026; F21K 9/54; F21V 29/507; F21Y 2101/02
USPC 362/298

(57) ABSTRACT

A concealable lightweight low-profile solid-state light source which can be attached to or embedded in a mounting surface so as to blend with that mounting surface. The light weight concealable low-profile solid-state light source comprises at least one LED at least one reflector, at least one diffuser wherein the reflector and the diffuser form a light recycling cavity that recycles the light emitted by the LED until it is transmitted through and from the diffuser. The heatsink or heat dissipating surface does not extend or protrude more than a millimeter beyond the light emitting surface of the concealable low-profile solid-state light source.

### CROSS-REFERENCE TO RELATED APPLICATIONS

This application claims the benefit of U.S. Provisional Patent Application No. 61/914,373 which was filed on Dec. 10, 2013 and which is herein incorporated by reference.

This application is a Continuation in Part of U.S. patent application Ser. No. 14/204,476 filed on Mar. 11, 2014, which is a Continuation in Part of U.S. patent application Ser. No. 14/042,569 filed on Sep. 30, 2013, which is a Continuation in Part of U.S. patent application Ser. No. 13/572,608 filed on Aug. 10, 2012, which is also incorporated by reference.

This application is a Continuation in Part of U.S. patent application Ser. No. 13/986,793 filed on Jun. 5, 2013, which is herein incorporated by reference.

### BACKGROUND OF THE INVENTION

Most light sources are mounted into fixtures, which are then appended onto a mounting surface such as a wall, floor or ceiling. If it is desired that a light fixture be concealed in the mounting surface, this is typically accomplished by mounting it on the other side of the mounting surface and then drilling or cutting a hole in the mounting surface to expose the light emitting surface of the light source. However, penetration through the mounting surface and building material to which the light source is mounted may disturb the structural rigidity of the element that supports the mounting surface. Major through holes can also affect the fire retardancy, aesthetics and acoustical properties of the mounting surface. Clearly there is a need for a light source that can be mounted onto (or embedded into) a surface, such that the light source is unobtrusive, inconspicuous or concealed without affecting the structural rigidity, aesthetics, or fire retardancy of the mounting surface. There are difficulties in accomplishing these attributes with prior art light sources. Typically prior art solid-state light sources light sources have appended heatsinks to dissipate heat generated within the LEDs of the light source to ambient. These heatsinks require large portions of their surface area exposed to ambient.

Heat generated within the LEDs and phosphor material in typical solid state light sources is transferred via conduction means to large appended heat sinks usually made out of aluminum or copper. The temperature difference between the LED junction and heat sink can be 40° C. to 50° C. The temperature difference between ambient and the surfaces of an appended heat sink's surfaces is typically very small given that there is typically a significant temperature drop (thermal resistance) between the LED junction and the heat sink surfaces. With small temperature differences between the heat sink and ambient very little radiative cooling takes place. This small temperature difference not only eliminates most of the radiative cooling but also requires that the heat sink be fairly large (and heavy) to provide enough surface area to effectively cool the LEDs. The larger the heat sink, the larger the temperature drop between the LED junction and the surface of the heat sink fins. For this reason, heat pipes and active cooling is used to reduce either the temperature drop or increase the convective cooling such that a smaller heat sink volume can be used. In general, the added weight of the heat sink and/or active cooling increases costs for shipping, installation, and in some cases poses a safety risk for overhead applications. It would be advantageous if the heatsink temperature was close to the LED junction temperature to enable more radiative cooling of the light source.

Unlike conventional incandescent, halogen and fluorescent light sources, solid state light source are not typically flame resistant or even conform to Class 1 or Class A building code requirements. There are two types of fire hazards: indirect (where the lamp/fixture is exposed to flames) and direct (where the lamp/fixture itself creates the flames). Conventional solid-state lamps and fixtures can pose both indirect and direct fire threats because they use large quantities of organic materials that can burn.

Even though the LED die are made using inorganic material such as nitrides or AllnGaP which are not flammable, these LED die are typically packaged using organic materials or mounted in fixtures which contain mostly organic materials. Organic LEDs or OLEDs are mostly organic and also contain toxic materials like heavy metals like ruthenium, which can be released if burned. Smoke generated from the burning of these materials is toxic and one of the leading causes of death in fires due to smoke inhalation. Incandescent and fluorescent lighting fixtures typically are composed of sheet metal parts and use glass or flame retardant plastics designed specifically to meet building code requirements.

As an example, solid-state panel lights typically consist of acrylic or polycarbonate waveguides, which are edge lit using linear arrays of LEDs. A couple of pounds of acrylic can be in each fixture. Integrating these fixtures into a mounting surface can actually lead to increased fire hazard. Other many solid-state light sources rely on large thin organic films to act as diffusers and reflectors. During a fire these organic materials pose a significant risk to firefighters and occupants due to smoke and increased flame spread rates. In many cases, the flame retardant additives typically used to make polymers more flame retardant that were developed for fluorescent and incandescent applications negatively impacts the optical properties of waveguides and light transmitting devices. Class 1 or Class A standards cannot be met by these organic materials. As such a separate standard for optical transmitting materials UL94 is used in commercial installations. The use of large amounts of these organic materials in conventional solid-state light sources greatly increases the risks to firefighters and occupants due to their high smoke rate and tendency to flame spread when exposed to the conditions encountered in a burning structure. A typical commercial installation with a suspended ceiling contains 10% of the surface area as lighting fixtures. Walls, floors and ceilings are typically designed to act as a fire barrier between rooms. However lighting fixtures which are installed by penetrating through the mounting surface with large holes can compromise the effectiveness of this fire barrier by providing a pathway for flames to bypass the mounting surface barrier of a wall, floor or ceiling. For this reason even incandescent and fluorescent fixtures are typically required to have additional fire resistant covers on the on their backsides (opposite their light emitting sides). These fire enclosures increase costs and degrade the ability to effectively cool the light fixture. Given that most solid state light sources depend on backside cooling these fire enclosures lead to higher operating temperatures on the LED die and actually increase the direct fire hazard for solid state light sources. The large amount of organics in the solid state light fixtures can directly contribute to the flame spread once exposed to flames either indirectly or directly.

The need therefore exists for solid state lighting solutions which are Class 1 rated which can reduce the risks to occupants and firefighters during fires and minimize the direct fire hazard associated with something failing with the solid state light bulbs.

There have been numerous recalls of solid-state light sources which further illustrate the risks based on the solid-state light sources themselves being a direct fire hazard. In the recalls, the drive electronics over-heated, which then ignited the other organic materials in the light source.

The need exists for solid state light sources, which will not burn or ignite when exposed to high heat and even direct flames.

To not materially affect the fire retardancy of the mounting surface or building elements upon which the light source is mounted the light source must be minimally invasive into the mounting surface. This requires that the light source be very thin in profile if it is placed or embedded such that the light emitting surface is flush with the mounting surface. For prior art solid-state light sources this requirement is difficult to achieve because of the high brightness of light emitting diodes. Large mixing chambers are typically used to diminish the glare created by the LEDs in the solid-state light sources. These large mixing chambers typically have depths which are thicker than the building elements the mounting surfaces are attached to, thereby requiring large through holes in the mounting structures.

LEDs are point source of light, which have brightnesses on the order of several million ftL, which can not be comfortably viewed directly. The end user characterizes this as glare or glint. As such even Fresnel reflections, dust particles, chips or other defects can create very intense glare or glints off the intermediate or final optical surfaces of the light sources. This is easily seen in the majority of imaging and non-imaging LED light sources creating undesirable glare or glint. In the past the motivation has been to take advantage of the point source nature of the LED package whereby a simple imaging or non-imaging optic can be designed, fabricated, and used to create a very specific far field intensity distribution pattern. This however leads to increase glare and glint because skew rays or scatter rays are very difficult to eliminate in this type of illumination design. A simple Fresnel reflection can be as large as 4% for each surface of a lens system. This creates skew rays, which may be end up as glare or glint to the end user. Even non-imaging approaches can suffer from glare or glint if a solid element is used or a protective cover glass is used that can accumulate dust or scratches. Ideally illumination is based on light sources, which closely match the desired output etendue from the source or fixture to eliminate glare and glint. As an example, sources with surface brightness of only 50,000 ftL can deliver 25,000 lumens per square foot with an optical gain of 2. This is more than competitive with commercial LED based street light fixtures yet the glare or glint potential is reduced by almost 100× over streetlight designs in which the majority of the rays emitted by the LED packages pass directly through the optical imaging element. For illumination it is therefore desirable therefore from a glare and glint standpoint to use sources which have etendues only slightly smaller than the desired output etendue. This has lead to adoption of large area emitters in many illumination applications. Large surface emitters are typically formed based on fluorescent technology. However, fluorescent sources typically require through holes in mounting surfaces if the light emitting surface is to be flush with the mounting surface. Fluorescent sources also introduce mercury into the environment and use large quantities of rare earths. The need therefore exists for surface emitters, which exhibit surface brightness below 100,000 ftl and use a minimum amount of raw materials. In both the incandescent and fluorescent cases the weight of the light sources has over time been minimized because ultimately weight impacts not only costs, but also life costs and environmental impact. The heavier the light source, the more raw materials are required and the larger the environmental impact. Lighter weight light sources also decreases the amount of raw materials required by any lighting fixture or supporting elements such as a suspended ceiling. Presently, a single 2 foot×4 foot solid state troffer can weigh more the 10 lbs even though the LED die or packages weigh only a few grams. The sheet metal housing, diffusers, heatsink, and mounting hardware all increase costs from material, shipping, and stocking standpoint. The added weight of these elements means that each troffer must be separately supported with wires to the deck in the case of suspended ceilings. For other applications, the troffers must be attached via nails or other attachment means to rafters or other support means. In addition, large quantities of organic materials are typically used in LED based fixtures. Unlike incandescent and fluorescent light source which are constructed of inorganic non-flammable materials such as glass, metals, or ceramics, most conventional LED based fixtures have diffusers, waveguides, and reflectors which are based on flammable materials which contribute not only to flame spread but also to smoke generation. In general conventional LED light sources generate between 1 and 10 lumens per gram. Therefore, in the quest of low glare, uniform output light sources,—large mixing chambers, waveguides and reflectors add undesirable volume, flammability and weight to LED light sources.

OLED technology is proposed as an alternate to LED light sources. These light sources typically have low profiles and uniform light output. However the high cost, limited lifetime, use of toxic materials, low surface brightness, low efficiency and moisture sensitivity of OLEDs have limited their usefulness in general lighting applications. The need exists for low profile lightweight LED based light sources which are can overcome the deficiencies of existing LED based light sources while simulating the look of OLEDs or fluorescents without using toxic materials such as mercury and other heavy metals.

Recycling cavities are disclosed by Zimmerman in U.S. Pat. No. 7,040,774 with and without wavelength conversion, which is commonly assigned and incorporated by reference into this invention. The recycling cavities are used to transform the etendue of light sources within the recycling cavity into smaller or larger etendues via recycling. The recycling cavities disclosed in these patents also allow for efficient mixing or averaging of multiple solid state emitters and/or wavelength conversion elements. Solid state emitters in which the light emitting surface also is used as the heat extraction surface are disclosed by Zimmerman in U.S. Pat. No. 7,804,099, which is commonly assigned and incorporated by reference into this invention. U.S. Pat. No. 8,704,262 by Livesay, which is commonly assigned and incorporated by reference into this invention, discloses the use of thermally conductive luminescent and/or translucent elements with recycling cavities whereby the heat generated within the recycling cavity is dissipated to the surrounding ambient substantially by the light emitting surfaces.

If light sources are to be mounted to their mounting surfaces such that the lightning service is flush with the mounting surface without large penetrating holes through the mounting surface this requires that the majority of the heat be dissipated on the output side of the light source. A novel method of accomplishing this is described in U.S. Pat. No. 8,704,262, which is commonly assigned and incorporated by reference into this invention, which is the parent of this continuation in part application. It is also important than large enough surface area for dissipating the heat generated by the LEDs within the light source such that the exposed heated surface is not too hot for humans to touch. Underwriters laboratories requires less than 90° C. for exposed light sources accessible to touch.

In general, the need exists for concealable low-profile ultra light weight light sources, which output greater than 10 lumens per gram, which maintain an external surface temperature of less than 90° C., are less than 5 mm in thickness, have nonglare uniform output, can be embedded or attached to a mounting surface whereby they blend into that mounting surface, utilize Class A or non-flammable materials, conduct heat through the light emitting surface and utilize a minimum of raw materials.

### SUMMARY OF THE INVENTION

An extremely low profile LED light source is disclosed which has uniform light output, low glare, ultrathin profile, extremely light weight and can be easily concealed or mounted, such as to blend into the mounting surface without requiring full penetration, or significantly comprising the structural rigidity, or altering the aesthetics or fire retardancy of the mounting surface. There are several requirements which are met by this light source to accomplish these objectives. In addition, the light source of the subject invention has a surface appearance that blends with the mounting surface. Disclosed is a concealable low profile light source comprised of at least one light emitting diode (LED), a highly reflective diffuser, a reflector wherein the highly reflective diffuser and the reflector form a light recycling cavity that mixes and diffuses the light emanating from the LED contained within the light recycling cavity. To achieve a uniform output in a very thin profile and the above performance objectives it has been found necessary to utilize a highly reflective diffuser where most of the incident light is reflected on the first bounce back within the cavity. The diffuser preferably has a reflectivity of greater than 70%, more preferably a reflectivity of greater than 80%, and most preferably a reflectivity of greater than 85%. To achieve a light source where the majority of the heat is dissipated to the light emitting side of the light source, the diffuser has high thermal conductivity. The diffuser preferably has a thermal conductivity of greater than 1 W/M-° K, more preferably a thermal conductivity greater than 10 W/M-° K, and most preferably a thermal conductivity greater than 20 W/M-° K. To achieve overall high efficiency of light output from the light source it is desirable to maintain a light reflectivity averaged over all of the exposed surfaces within the light recycling cavity of greater than 90%. Because of the high reflectivity of the diffuser, to achieve high output efficiency the average reflectivity within the cavity must be quite high. In addition elements within the cavity that either absorb light or have low reflectivity must be kept to a very small cross-sectional area as a percentage within the cavity. Preferably the average reflectivity within the cavity must be over 70%, more preferably the average reflectivity within the cavity must be over 80%, and most preferably the average reflectivity within the cavity must be greater than 85%. In a prototype light source of the present invention an average reflectivity of greater than 90% was achieved for the light recycling cavity. This resulted in more than 80% of the light emitted by the LED within the light recycling cavity being output by the light source through the diffuser. Another requirement of this light source, to be mounted flush with the mounting surface with no through hole that penetrates completely the mounting surface, is that all of the heat generated by the LEDs within the light recycling cavity is thermally conducted to the light emitting side of the light source. Light sources, which emit greater than 10 lumens per gram, are disclosed. More preferably these sources would maintain an external surface temperature under 90° C. and be constructed substantially of non-flammable materials. These sources are based on LED die and/or packages mounted within high efficiency recycling cavities. As such reflectivity and absorption losses must be minimized with reflectivity greater than 90% and absorption losses less than 5% over the light source emission wavelengths. Heat transfer to the surrounding ambient may be via the emitting surface, the recycling cavity reflector, or both the emitting surface and recycling cavity reflector. In general, LED point sources with source brightness in excess of 4 million ftL are etendue transformed using recycling cavities into diffuse lambertian or isotropic sources with surface brightness less than 100,000 ftL and even more preferably less than 10,000 ftL such that glare and glint are minimized. By transforming the internal LED point sources small etendues into large area high etendue sources using a highly reflective light recycling cavity it becomes possible to simultaneously use the surfaces of the recycling cavity which transformed the small etendue into large etendue to also dissipate the heat generated in the light source to the surrounding ambient. In a sense, both the etendue and heat dissipation area can be increased using this approach without increasing the depth of the light source. In addition the impact on the environment associated with raw material usage can be minimized by combining the heatsink and optical transformation (e.g. diffuser) element into one element. Even further using the light recycling cavity to not only transform the etendue of the LED packages and cool the light sources but also form the support structure typically defined as the fixture is disclosed. As such decorative elements, mounting elements, swivel elements, power conversion elements, and electrical/data interconnect elements can be incorporated into at least one of the elements forming the light recycling cavity thereby further reducing the raw materials required to deliver uniform illumination desired by the end user. The light weight nature of the disclosed light source, eliminates the need for the structural support typically required by prior art light sources for mounting. Applications include mounting into or on conventional suspended ceilings, light weight grid systems based on carbon fiber tubing, metal tubing, wire, fabrics, non-woven, and other lighter weight suspension systems. This includes retrofittable approaches, which can be easily snapped or otherwise attached to existing support structures such a ceiling grids. Recycling light cavity light sources with maximum surface temperatures less than 90° C. are preferred from both a touch temperature standpoint and being able to mount the light sources on flammable surfaces such as sheetrock, fabrics, and papers per building code requirements. Even more preferably, the maximum surface temperature is less than 60° C. Etendue transformation is via recycling elements including but not limited to air cavities, gas filled cavities, liquid filled cavities, partial waveguides and full waveguides are also disclosed. Inorganic non-flammable materials are preferred. Diffusing elements with less than 20% in line transmission are preferred (greater than 80% reflectivity) to allow for sufficient light recycling to create uniform light output emission through the light emitting element while keeping the overall light source thickness less than 5 mm. It is important to note that optical absorption losses must be minimized in the disclosed recycling cavity designs as the number of reflections within the recycling cavity may exceed 40 bounces before the majority of the photons escape the recycling cavity. Unlike conventional mixing chambers which typically require LED package spacing and the thickness of the mixing chamber to essentially equal to create uniformity the use of low in-line transmission light transmitting elements and increased number of bounces within the recycling cavity can greatly reduce the thickness of the light source for a given LED spacing.

The number of reflections is critical to creating intensity uniformity and providing for more complete etendue transformation. Unlike imaging and non-imaging optical approaches, recycling optics as first disclosed by Zimmerman is not based on single pass geometric optical design rules. Recycling cavities can be used to decrease or increase the etendue of the light source output if the reflectivity of the average light recycling cavity of the light source is sufficiently high. By using recycling cavities constructed of lightweight thermally conductive elements, not only does the light source of this invention increase the etendue of the LEDs or LED packages within the light source but it also spreads the heat generated by the LED packages over the outer surfaces of the light recycling cavity. Thereby providing a large surface area such that the heat can be transferred to the surrounding ambient. The disclosed light sources emit greater than 10 lumens per gram and more preferably greater than 30 lumens per gram. Preferably the output surface has a brightness of less than 100,000 foot lamberts. More preferably the output surface brightness is less than 20,000 foot lamberts and most preferably the output surface brightness is less than 10,000 foot lamberts. Emission from the sources may be lambertian, directive, or isotropic in nature. A typical office space of 1000 square feet requires approximately 30,000 lumens of lighting. The light sources disclosed are capable of delivering the 30,000 lumens with less than 1 kg of light source weight.

Depending on the surface brightness of the source the light source emitting surface area may be between 0.3 square feet to several square feet. The use of additional light directing elements incorporated into and mounted to the light source is also disclosed to impart directivity and further reduce glare or glint. The light sources disclosed may be suspended by power leads, attached to suspended ceiling grids, integrated into ceiling tiles, be freestanding elements or mounted onto a surface within the room. Most preferably the light recycling cavity is formed by the lighting source itself without the need for additional external housings. This not only creates a minimalistic design thereby reducing raw materials usage but also can create a very aesthetically pleasing look for the end user. In general, the light sources disclosed transfer a substantial portion of the heat generated within the light source to the same ambient environment that light from the light source is emitted into without the need for additional heatsinking elements. Alternately, some portion of the heat generated within the light source may be transferred into the mounting surface or structure via conduction and spread out over a larger surface area than the surface area of the light source. While the use of the light emitting surface as the primary cooling surface is preferred the main intent of the invention is to disclose light source which use a minimum amount of raw materials both transmissive and opaque to form etendue transforming systems such that light sources emitting greater than 10 lumens per gram can be realized. It is recognized and disclosed that the light recycling reflector in particular can be effectively used to spread the heat from the localized LED packages or wavelength conversion layers over a large area with a minimum thickness. Commercially available reflector material such as Alanod™, which is silver coated aluminum, is a preferred material choice for cavity reflector. In order to create light sources emitting greater than 10 lumens per gram the amount of material or thickness in particular becomes a critical parameter in the light source design. The disclosed light sources form thin rigid handable light sources based on forming recycling cavities using highly reflective materials like Alanod or other reflective materials such that the high reflectance layer is internal to the cavity and the rigidity is imparted to the light source by bonding the recycling cavity elements.

As an example, a ½ inch wide×24 inch long×5 mm thick Alanod reflector is formed 3 dimensionally to form a bathtub like element onto which four ½ inch wide×6 inch long×500 micron thick piece of alumina is bonded to form the recycling cavity. The resulting ½ inch wide×24 inch long×5.5 mm thick light source is rigid and more handable than a fluorescent tube and does not represent the explosive hazard of the vacuum fluorescent tube or contain any heavy metals like mercury. The weight of the disclosed light source is less than 30 grams and can emit greater than 1000 lumens (e.g. 33 lumens per gram) while maintaining a surface temperature under 60 C in any mounting orientation. In this particular embodiment the LEDs or LED packages can be mounted anywhere within the recycling cavity via an interconnect means also within the light recycling cavity as long as the heat is transferred to at least one of the elements comprising the light recycling cavity. Alternately, the one or more of the 3D reflector surfaces can be replaced with a light transmitting element like the alumina to change the far field light distribution of the disclosed light source. Organic materials may be used but it is noted that flammability, rigidity, life, and thermal performance may be compromised. As an example, diffuse organic reflectors like those made by White Optics may be substituted for the Alanod reflector but the light strip will be less rigid, there will be less effective surface area for heat transfer, and the light source will now burn and emit smoke when exposed to an open flame. More preferably, organic materials are minimized in the disclosed light sources. Materials such as glasses may be used which will decrease the thermal performance but do not create fire hazards as with organics. More preferably alumina or similar such materials with high thermal conductivity and high reflectivity are used as the diffuser thereby providing minimum thermal impedance with high optical efficiency.

Solid waveguides may also be used to increase rigidity but will add considerable weight. Most preferably the light sources disclosed are based on air or gas containing recycling cavities with the minimal amount of additional light guiding elements. In general, the lightweight (greater than 10 lumens per gram) recycling light sources based on metals, ceramics and other inorganic materials with thicknesses less than 1mm are used to form air or gas filled recycling cavities. The inner surfaces of the light recycling cavities have reflectivity greater than 90% and light transmitting elements with in-line transmissions less than 30% with optical absorption losses less than 10%. Using this approach the disclosed light sources/fixtures, efficient etendue transformation of point sources into large area sources, rigid/handable light sources/fixtures, and emitting greater than 10 lumens per gram while maintaining an external surface temperature of less than 90° C. may be realized. Given that more than 200 million square feet of lighting fixtures (equivalent of 30 million troffers) are sold in the US every year just into commercial suspended ceiling applications and that conventional LED troffers weigh approximately 4.5 kg and output 3000 lumens. Raw material usage could be dropped from over 135 million kg per year to less than 3 million kg per year using the light sources with greater than 30 lumens per gram output disclosed in this invention. In addition, all the material processing, shipping costs, storage costs, and distribution costs are reduced accordingly.

### BRIEF DESCRIPTION OF THE DRAWINGS

FIG. 1 depicts a side view of a prior art conventional solid state troffer.

FIG. 2 depicts a side view of concealable low profile solid state light source.

FIG. 3A depicts a side view of lightweight recycling cavity LED light sources with extended reflector for added heat dissipation, which can be attached to a T-grid of a suspended ceiling. FIG. 3B depicts a side view of detachable lightweight recycling cavity LED light sources with extended reflector.

FIG. 4A depicts a side view of strip lights with extended reflector cooling elements attached to the T-bar via connectors. FIG. 4B depicts a side view of strip lights with extended reflector cooling elements with a gap between the ceiling tile and the reflector.

FIG. 5A depicts a side view of recessed heatsink elements for flush mounted strip lights with the light source formed by a reflector and a diffuser forming a light recycling cavity. FIG. 5B depicts a side view of recessed heatsink elements for flush mounted strip lights with reentrant heatsinks split and located on the sides of the reflector.

FIG. 6A depicts a side view of ceiling tile elements with a waveguide element with a back reflector and scattering or turning elements within the waveguide elements. FIG. 6B depicts a side view of ceiling tile elements with additional cooling means embedded in the ceiling tile elements.

### DETAILED DESCRIPTION OF THE DRAWINGS

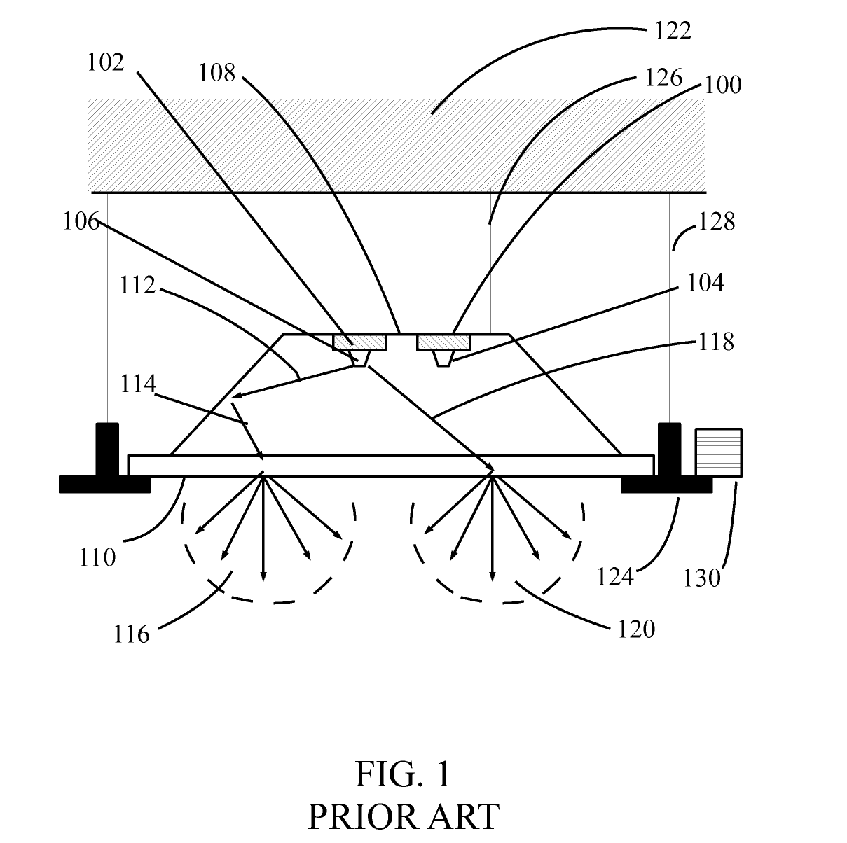

FIG. 1 depicts a prior art led troffer fixture. The reflector housing 108 is typically sheet metal with a reflective coating to which metal core interconnect boards 100 and 102 are mounted. LED packages 106 and 104 are further mounted on the metal core interconnect boards 100 and 102. The reflector 108 is typical several inches deep and the light rays 112, 114, and 118 are directed to the diffuser 110 where the light 116 and 120 escapes from the fixture. The diffuser 110 is typically plastic sheeting with in-line transmission of between 80% and 60%. Heat from the metal core interconnect boards 100 and 102 is coupled to the reflector housing which may typically contains additional heatsinking elements. A typical LED troffer weighs approximately 10 lbs. and outputs 3000 lumens or less than 1 lumen per gram. As such the LED troffer fixture must be secured to the deck 122 via support wires 126. This is separate from the suspended ceiling, which consists of grid 124 and ceiling tiles 130 which attached to the deck 122 by support wire 128. This is due to seismic and terrorist standards imposed on by federal and local building codes. The heat from the LED troffer fixture substantially is dissipated into the space between the deck 122 and top of the ceiling tiles 130.

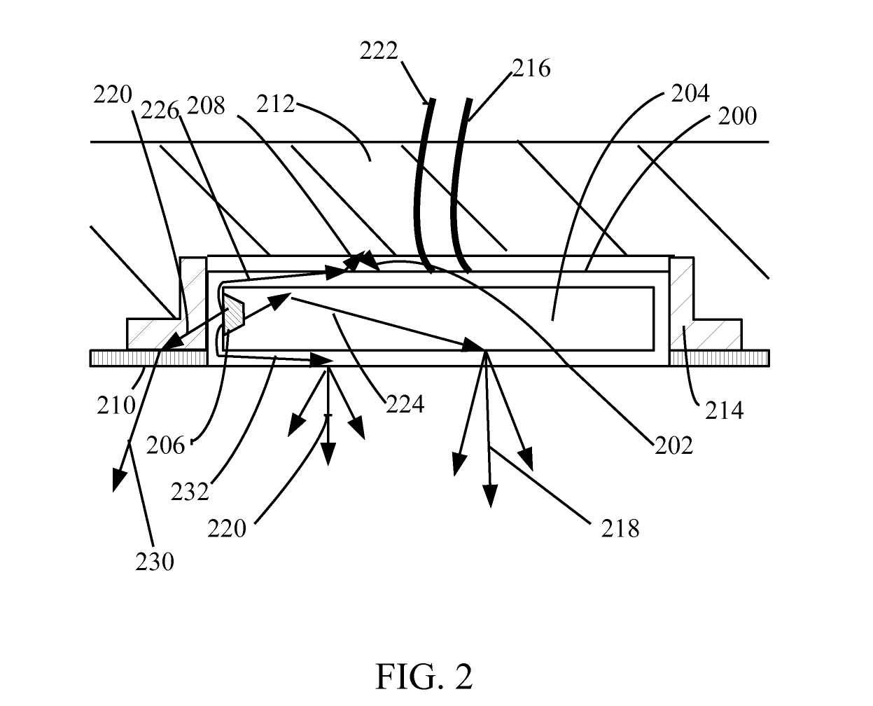

FIG. 2 depicts a general concealable low profile light source comprising a recycling envelope 200, which contains at least one cavity 204 which is preferably air or some other media with low optical absorption within the visible and infrared spectrum. At least one cavity may also be filled with a liquid, porous material or solid material as long as the optical absorption is less than 10 cm−1. At least one LED package 206 emits light into the at least one cavity 204 whose interior surfaces have an average reflectivity greater than 90% even more preferably greater than 95% for light emitted by at least on LED package 206 which may be mounted anywhere within the cavity as previously disclosed by the authors of this invention as shown in light rays 224 which eventually exit the light source as shown in light rays 218. The recycling envelope 200 may consist of ceramics, crystalline, polycrystalline, inorganic/organic composites, metals, or combinations of these materials. Most preferred is that at least a portion of the recycling envelope 200 be constructed of a light transmitting low optical absorption material like alumina, glass, zirconia, TPA, or composites of these materials. At least one LED package 206 also transfers the heat it generates via thermal conduction paths 226, 232, and 220 as shown. Most preferably the majority of the heat is transferred to surrounding ambient via thermal conduction path 232 and 220. Using this approach the concealable low profile light sources disclosed in this invention can be embedded into building materials 212 which are not thermally conductive like sheetrock, wood, paneling, flooring, concrete, and ceiling tiles. As shown in heat rays 208 and 202 heat transfer through the building material 212 is most preferably frustrated by the low thermal conductivity which typically exists in typical building materials. Typically building materials have thermal conductivity less than 0.1 W/mK. Using this approach heat from the at least one LED package 206 is conducted via thermal conduction paths 232 into the light emitting portion of the light source and radiatively and convectively transferred to the surrounding ambient as shown by heat rays 220. As previously discussed at least a portion of recycling cavity 200 is constructed of a material like alumina which exhibits not only low optical absorption but reasonable thermal conductivity and reasonable emissivity such that a significant portion of the heat generated by at least one LED package 206 can be transferred effectively to the surrounding ambient even though thermal conduction path 226 is frustrated by the low thermal conductivity of building material 212. Alternately or in combination with thermal conduction path 232, thermal conduction path 220 may be used to further cool at least one LED package 206 using optional heat spreading layer 214 which most preferably is concealed behind overlay 210 which may consist of a scrim, veneer, paper, wall paper, plastic protective coating, paint, glass cover, or other concealing element. As an example a 2 foot×2 foot ceiling tile can become a very effective heat dissipation element if a thin aluminum or other thermally conductive materials is hidden behind the scrim layer or some other overcoat. Even though overlay 210 may not have high thermal conductivity the ability of optional heat spreader 214 to increase the effective cooling surface area via thermal conduction path 220 and the resulting radiative and convective transfer to the surround ambient as shown in heat rays 230 can be used effectively to dissipate more of the heat generated by at least one LED package 206. Another key attribute of this invention is the thickness of the recycling cavity 200 relative to the thickness of building material 212. Most preferably the thickness of recycling cavity 200 is less than half the thickness of building material 212. Even more preferably the thickness of recycling cavity 200 is less than 10 percent of the building material 212. As an example a typical ceiling tile is greater than one half inch thick (12 mm). As such a recycling cavity 200 less than 6 mm thick is preferred. This puts certain requirements on the recycling cavity regarding the number of reflections light ray 224 must experience in order to create a thin uniform light source as desired in most light installations. Most preferably the only element of the concealable low profile light source which penetrates the building material 212 are the electrical leads 222 or 216. Using this approach the thermal, acoustical, seismic, or other barrier properties of the building material 212 can be left largely intact. In the case of systems in which electrical power is integrated into the building material 212 even the electrical connections 222 and 216 can be implemented with breaking the barrier properties of building materials 212. In some instances the properties of the building materials can be even enhanced such as mechanical rigidity. As an example, the recycling cavity 200 may be bonded or otherwise adhered to building material 212 such that the mechanical rigidity of the overall assembly is enhanced. Construction materials and process incorporated into recycling cavity 200 based on roll forming, bending, and otherwise forming metal elements, the incorporation of rigid lightweight elements like ceramics, glasses or composites, and the incorporation of rigid fillers into cavity 204 are all embodiments of this invention relative to enhancing the structural integrity of the building material 212. As a further example, recycling cavity 200 may be constructed of an alumina element through which light rays 218 exit the recycling cavity and also provides for thermal conduction path 232 such that heat rays 220 can also be coupled effectively via radiative and convective means to the surrounding ambient and an Alanod reflector forming the remainder of the recycling cavity 200 such that light rays 224 are reflected efficiently within cavity 204. While the Alanod reflector in this example does provide for thermal conduction path 226 it is not necessary for even high output light levels. A 9/16 inch wide×5 mm thick strip light 24 inches long can be embedded into a thermally insulative material such as a ceiling tile, output over 1000 lumens at 2600K while maintain a surface temperature under 45 C which is both touch safe and reasonable for LED package 206 operation. This performance level requires the inner surfaces of the cavity 204 to be greater than 90% reflectivity and that the LED packages 206 be spaced approximately one half inch apart.

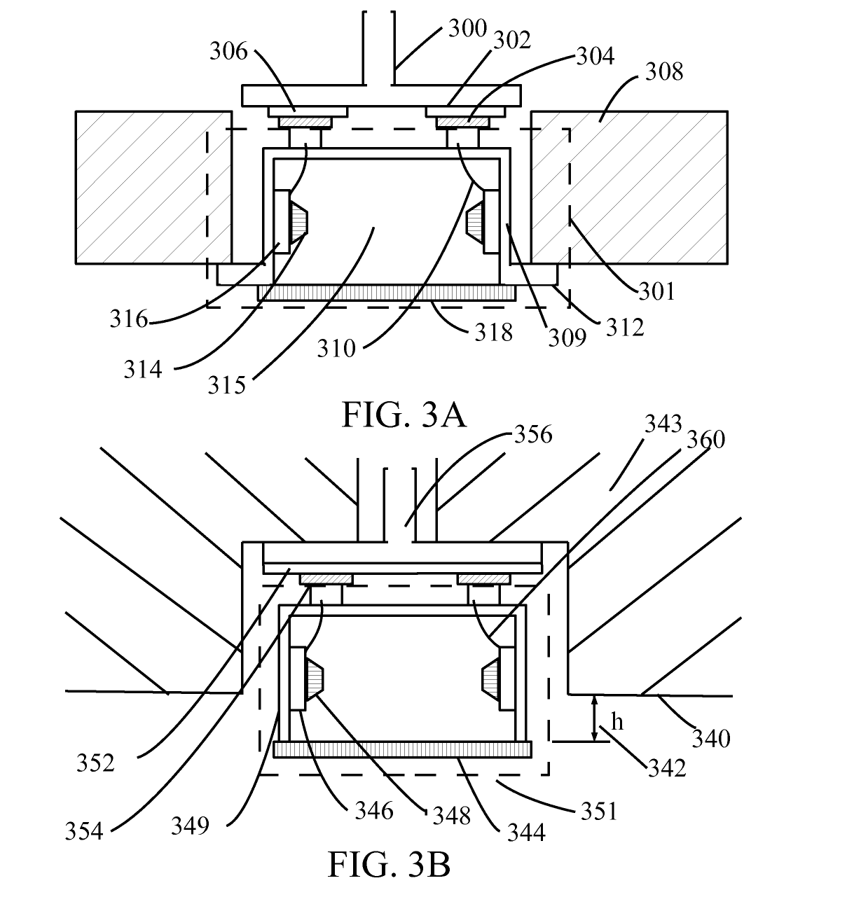

FIG. 3A depicts a detachable LED panel light 301 which can be attached to a T-grid 300 of a suspended ceiling 308. The light source 301 is approximately the same width as the T-grid 300 that is exposed below the ceiling. The LED panel light 301 would typically be the width of the T-bar but could be any length. This would have an appearance as a strip light. The main embodiment of this invention is that this LED panel light 301 has a low enough profile to be attached to the T grid with its light emitting surface flush or nearly flush with the lower surface of the ceiling. To achieve this low-profile while also providing very uniform light emission from the diffuser element 318 requires that the diffusing element which is light transmitting also has a high reflectivity. This creates a light recycling cavity formed by the reflector 309 and the diffuser 318. LEDs 314 are mounted to the reflector 309 facing into the light recycling cavity.

The LEDs 314 are mounted on a sub mount 316 which connect the LED 314 via an interconnect 310 to external interconnects 306 and 304 which connect to powered rails 302 mounted on the T-bar 300. Interconnect 310 maybe a flex circuit, wire, or other electrically conductive means for connecting submounts 316 to external interconnects 306 and 304 The heat generated by the LEDs is thermally conducted by the reflector which preferably is of aluminum having relatively high thermal conductivity. The heat is conducted through the reflector to the wings 312 of the reflector 309 whose lower surface is exposed to the ambient of the illuminated space below the ceiling. The wings 312 of the reflector 309 extend out to expose enough surface to adequately dissipate the heat generated by the LEDs via convection and radiation into the illuminated space below the ceiling. The diffusing element 318 is selected to have enough reflectivity to create multiple reflections of light from LEDs within the light recycling cavity 315 such that the emitting surface of the diffuser 318 appears very uniform and brightness as viewed by occupants in the room being illuminated. The contacts and/or connectors 306 of the light source 301 can be mechanical attachment or more preferably magnets. In this way the light source can easily be detached from the T-bar without disturbing the integrity of the ceiling. The preferred embodiment of this invention is a low-profile light source which has: a height of less than 5 mm, can be attached directly to a T-bar of a ceiling, is easily detachable and reattached easily to the T-grid of the ceiling, and most preferably its emitting surface is flush with our extends less than a millimeter below the lower surface of the ceiling. A further property of this lightweight low profile LED panel is that it has a uniform output such that the light output over the entire light emitting surface looks uniform to the unaided eye and that the luminance of the light emitting surface does not vary more than ±20%, more preferably not more than ±10% and most preferably not more than 5%. Further that there are no visible hot spots created by the LEDs inside the light source. Further the diffuser that is used for this light source has an in line transmission of greater than 20% and it reflects over 80% of the light incident upon the diffuser back into the light recycling cavity 315 of the light source 301. An alternative embodiment of the invention is a low profile light source (as depicted in FIG. 3A) without the wings 312. The heat from the LED is conducted through the thermally conductive reflector to thermally conductive contacts or connectors to the T-grid. Optionally additional thermal contacts or inserts in thermal contact to the T-bar can be interposed between the T-bar and the aluminum reflector. In this way the heat from the LED is conducted to the reflector where it is then thermally conducted to the T-bar. If the low-profile LED panel light does not run at high luminance levels (e.g. less than 500 or 300 foot lamberts) the T-bar itself may be sufficient to dissipate the heat from the light sources. However this will depend on how many light sources are mounted to the T-bar.

FIG. 3B depicts another way of practicing the invention. Shown is a detachable light source 351 with a reflector 349 and diffuser 344. LEDs 348 mounted within the light recycling cavity on substrates 346 which are mounted to the inside surface of the reflector and interconnect 360 connects the LED 348 to the external contacts of the light source 351. Power rails 354 on dielectric layer 352 provide power to the light source 351. In this embodiment the panel light source has a larger thickness or profile wherein the reflector 349 extends beyond the lower surface of the ceiling or ceiling the 343 and thereby exposing the outside of reflector to the ambient of the illuminated space below the light source 351. This allows enough surface area to be exposed such that heat thermally conducted through the reflector (from the LED mounted on its inside surface) to the exposed outside surface can be convectively cooled and/or radiated into the illuminated space below the ceiling. The amount of protrusion depth 342 (depicted as h) is selected to expose enough surface area to ambient to adequately cool the LEDs via convection and radiation from exposed outside surface of the reflector. Most preferably the surfaces of light source 351 have a substantially similar color, texture, and aesthetic look as scrim layer 340 of the ceiling tile 343.

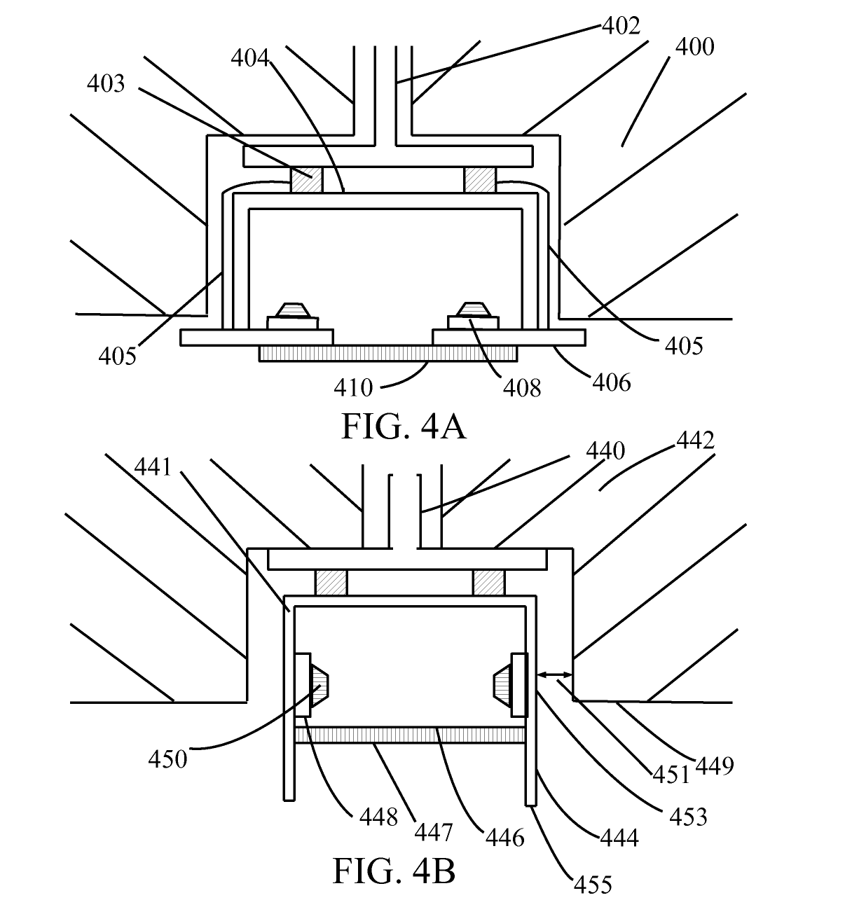

Shown in FIG. 4A is another way of practicing the embodiment described in FIG. 3A. Light source 400 is attached to the T-bar 402 via connectors 403. In this case LEDs 408 are mounted to metal core circuit boards (e.g. T-Clad substrates manufactured by Berquist) which form the cooling wings 406 previously described in FIG. 3A. Using metal core boards makes the LED interconnect easier and isolates the LED electrically from the reflector 404. A wired interconnect or flex circuit 405 can connect the metal core board to the electrical contact or connector 403 of the light source to the powered T bar grid 402

FIG. 4B depicts another means of practicing the invention. In this embodiment the light source 442 is made narrower than the channels required by the T-bar 440. This forms a gap 451 between ceiling tile 449 and reflector 444. As described previously the LEDs 450 are mounted on substrates 448 which are in turn mounted to the aluminum or other highly reflective material reflector. It is important in all of these embodiments that the reflector have a reflectivity of greater than 95% and more preferably greater than 98%. The diffuser 446 in this case is actually set inside the reflector 444 such that the reflector 444 extends below the diffuser surface 447 as indicated by 455. This provides shielding of the light source so more directional output can be achieved. Alternatively the reflector 444 does not extend below the imaging surface of the diffuser 446 and is flush with the lower surface of the tile or ceiling 449. Since a gap is formed between the ceiling tile 449 and the reflector 444 this allows the two vertical outside surfaces of the reflector to dissipate the heat generated by the LEDs convectively and radiatively into the ambient space below the ceiling. This is not quite as effective as a heat dissipating surface that is facing down into the ambient below the ceiling however it does allow the light source to be flush with the ceiling without anything protruding below the lower surface of the ceiling or ceiling tiles 449.

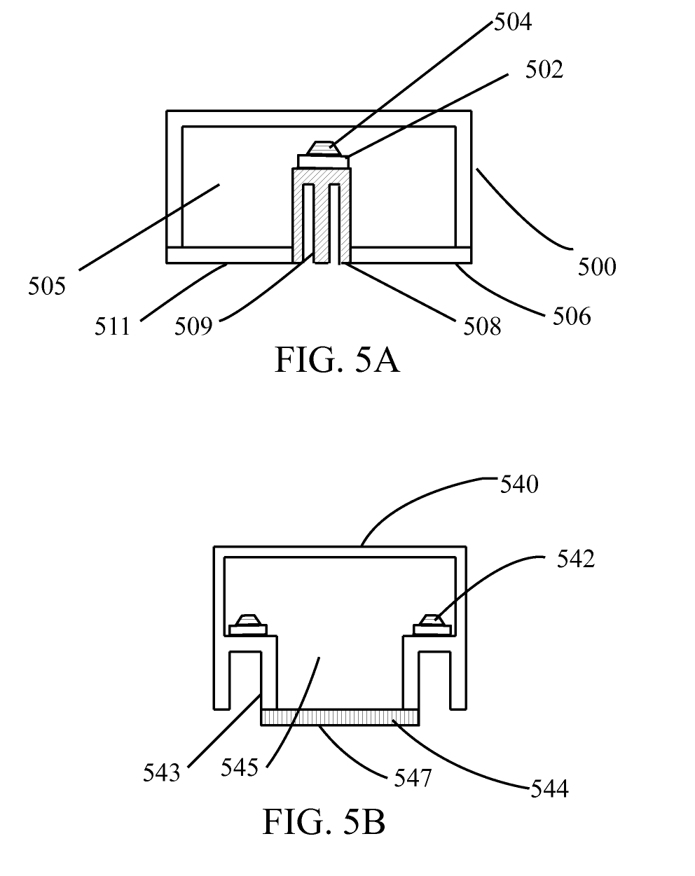

FIG. 5A depicts another means of practicing the invention. In this embodiment the light source is formed by reflector 500 and diffusers 506 and 511 forming a light recycling cavity. The diffuser preferably will have the same reflectivity characteristics as previously described. In this embodiment the LED 504 is mounted to a substrate 502 which contains an interconnect not shown. This is mounted to a reentrant heatsink 508. The depth of the channels 509 of the heatsink 508 is selected to form enough surface area to dissipate the heat convectively and radiatively, which is generated by the LEDs 504. In this manner since the heat sink does not protrude below the emitting surface of the diffuser 506 the light source can be made very low profile (less than 5 mm thick) and attached to the T-bar without extending below the ceiling tile (not shown) or the lower surface of the ceiling.

FIG. 5B depicts another means of forming a low-profile light source 545. In this case the reentrant heatsinks depicted in FIG. 5A are split and located on the sides of reflector 540. The channels formed by the heatsink 543 are deep enough to provide enough surface area to convectively and radiatively dissipate the heat from the LEDs 542 mounted to the interior facing surface of the heat sink and reflector. Again, since the heat sinks do not protrude below the emitting surface 547 of the defusing element 544 these light sources can be very low profile and be mounted within and onto a powered T-grid without protruding below the lower surface of the ceiling tile or ceiling.

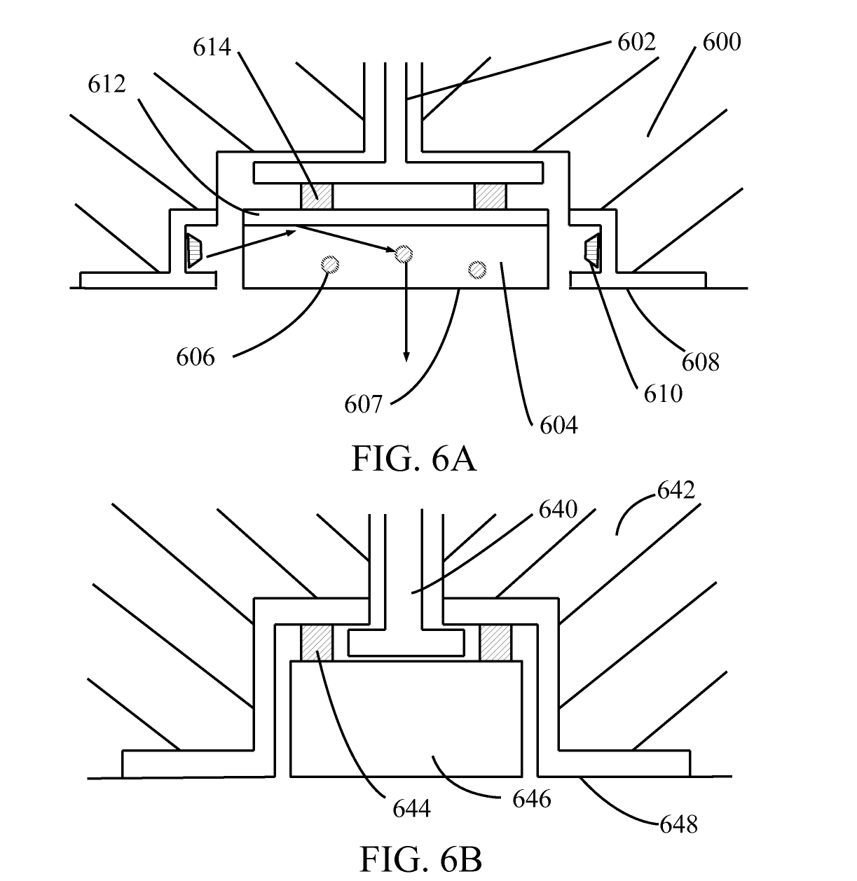

FIG. 6A depicts a waveguide element 604 with a back reflector 612 and scattering or turning elements 606 within waveguide element 604 cause the light rays shown to exit from the surface 607 of the waveguide element 604. The LED packages 610 mounted into a reflector/heatspreading element 608 which is embedded in ceiling tile 600. Once in place the light rays from the LED package 610 are coupled into the edges of waveguide 604. The back reflector 612 is attached to grid 602 via attachment means 614 which may include but not limited to adhesives, magnets, clips, Velcro, or other mechanical means. This approach can be used to create a wide range of aesthetic looks including mirrored tiles.

FIG. 6B depicts additional cooling means 648 embedded in ceiling tile 642. A thermal transfer element 644 conducts heat from the light source 646 into the additional cooling means 648 which may be mounted under the scrim layer of ceiling tile 642. In this manner a larger cooling surface area can be realized while extending the light source 646 surface area while still mounted to T grid 640.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

1) A concealable low profile light source comprising
at least one light emitting diode (LED);
a highly reflective diffuser;
at least one reflector; and
wherein the highly reflective diffuser and the reflector form a light recycling cavity that mixes and diffuses the light emanating from said LED contained within the light recycling cavity and wherein the thickness of said concealable low profile light source facilitates its mounting onto a mounting surface without fully penetrating the mounting surface or significantly affecting the structural rigidity of said mounting surface.

2) The concealable low profile light source of claim 1 wherein said highly reflective diffuser has a reflectivity of greater than 80%.

3) The concealable low profile light source of claim 1 wherein said at least one LED is mounted within said recycling cavity such that the majority of the light emitted by the at least one LED is directed away from the said highly reflective diffuser.

4) The concealable low profile light source of claim 1 wherein said concealable low profile light source has an overall thickness less than 5 mm.

5) The concealable low profile light source of claim 1 wherein said highly reflective diffuser is thermally conductive and wherein said at least one LED is mounted within said recycling cavity such that it is thermally connected to said highly reflective thermally conductive diffuser.

6) The concealable low profile light source of claim 1 wherein said highly reflective diffuser is thermally conductive and wherein said highly reflective thermally conductive diffuser has a body color that blends with that of the mounting surface.

7) The concealable low profile light source of claim 1 wherein the majority of the heat from the LED is conducted to the diffuser surface whereby it is radiated or convectively dissipated to ambient.

8) The concealable lightweight low-profile solid-state light source of claim 1 wherein the thickness of the light source including heatsink is less than 5 mm.

9) The concealable lightweight low-profile solid-state light source of claim 1 wherein the uniformity of the output luminance of the emitting surface of the light source does not vary by more than ±5%.

10) The concealable lightweight low-profile solid-state light source of claim 1 wherein the ratio of light output to weight of the light source is greater than 10 lumens per gram.

11) The concealable lightweight low-profile solid-state light source of claim 1 wherein the ratio of light output to weight of the light source is greater than 20 lumens per gram.

12) The concealable lightweight low-profile solid-state light source of claim 3 further comprising
magnetic electrical and mechanical connectors such that the light source can be easily attached or detached from a power T-grid of ceiling.
